(19) United States
(12) Patent Application Publication
(10) Pub. No.: US 2026/0235755 A1
(43) Pub. Date: Aug. 13, 2026

(54) SEGMENTED TRANSDUCER ELECTRODE FOR DIRECTIONAL POWER DISTRIBUTION OF SONAR ENERGY AND CONTROL SYSTEM THEREFOR

(71) Applicants: David A. Betts, Eufaula, AL (US); William Mark Gibson, Eufaula, AL (US); Justin Nicholas Devenish, Alpharetta, GA (US)

(72) Inventors: David A. Betts, Eufaula, AL (US); William Mark Gibson, Eufaula, AL (US); Justin Nicholas Devenish, Alpharetta, GA (US)

(73) Assignee: Johnson Outdoors Inc., Racine, WI (US)

(21) Appl. No.: 19/529,947

(22) Filed: Feb. 4, 2026

Related U.S. Application Data
(60) Provisional application No. 63/756,639, filed on Feb. 10, 2025.

(51) Int. Cl. G01S 15/96; G01S 7/52; G01S 7/521; G10K 11/00

(52) U.S. Cl. CPC G01S 15/96; G01S 7/52019; G01S 7/52053; G01S 7/5209; G01S 7/52096; G01S 7/521; G10K 11/006

(57) ABSTRACT

A curved monolithic transducer having a segmented positive electrode to provide directional power distribution of sonar energy and a control system and method to be used therefor are provided. The curved monolithic transducer includes a single negative electrode and multiple, individually powered positive electrodes that are energized by individual sonar power transmitters or a single sonar power transmitter via a variable resistance network. The transducer assembly may be mounted in various orientations, and the power delivery to each of the positive electrodes may be controlled in accordance with user settings or automatically in accordance with fishing modes or environments. Power distribution within the ensonification cone produced thereby may be varied as a result thereof.

### CROSS-REFERENCE TO RELATED PATENT APPLICATIONS

This patent application claims the benefit of U.S. Provisional Patent Application No. 63/756,639, filed Feb. 10, 2025, the entire teachings and disclosure of which are incorporated herein for all purposes by reference thereto.

### FIELD OF THE INVENTION

This invention generally relates to consumer multibeam phased array sonar systems, and more particularly to transmit sonar transducers for use therewith.

### BACKGROUND OF THE INVENTION

Consumer multibeam phased array sonar systems, such as that described in U.S. Pat. No. 11,914,066, entitled Multiplexed Phased Array Multibeam Sonar, filed Feb. 23, 2021, the teachings and disclosure of which are hereby incorporated in its entirety by reference thereto, utilize a single transmit (TX) element that is configured to generate a sonar ping to ensonify an ensonification cone of water in which the transducer unit is deployed. Such systems also include a receive (RX) array that is configured to receive sonar echoes resulting from the sonar ping contacting targets in the ensonification cone. These sonar echoes are then processed into sonar display information that is plotted on the user display.

In such a system the TX element is a curved ultrasonic transducer, such as made from a curved lead zirconate titanate (PZT) ultrasonic transducer tube. While operating frequencies may vary based on desired properties based on depth, resolution, etc., the TX element may be configured to generate the sonar ping at 1.05 MHz carrier frequency (f_{c}). The form of the sonar ping may also vary, and may be, e.g., a compressed high intensity radiated pulse (CHIRP) having a narrow bandwidth (S_{BW}), a continuous wave (CW) signal at 1.05 MHz carrier frequency (f_{c}) of a predetermined length, a relatively broadband input signal that sweeps a frequency range, etc. Such physical and electrical design and operation ensures efficient power utilization within the ensonification cone, which is of particular importance on a consumer watercraft on which such systems are powered by batteries.

Such sonar systems typically include analog and/or digital signal processing of the sonar echoes received by the RX elements or array to enable resolution of the object that generated the echo in a bandlimited spectrum, e.g., via beamforming filtering. Such processing preferably pulls down sonar echo data that lies outside of a usable dynamic range into a common system noise floor to suppress side lobe noise that otherwise could cause display distortion or unwanted noise on the user display.

While such analog and/or digital signal processing is capable of generating near real-time sonar images that enable an angler to view and track live swimming fish, lures, and jigs with remarkable clarity and accuracy, changes in the physical environment in which the consumer angler fishes present different challenges for such systems. For example, during a single fishing excursion an angler may fish in water that may vary from a depth of only a couple of feet to more than 200 feet. Indeed, even in a relatively fixed depth environment, the distance from the boat at which an angler may desire to cast may also vary greatly. Further, even at less drastic changes in depth, the bottom composition may vary from a hard rocky bottom to a very soft silty or mud bottom.

While in each of these changing environments, the sonar reflective nature of which varies greatly, typically the consumer angler is not able to adjust their sonar system to adapt. That is, the placement and angle of the sonar transducer in, e.g., a forward, down, or landscape mode or orientation, are set on the consumer watercraft during installation and are generally not able to be varied during the fishing excursion. As such, the angle and distribution of sonar energy may result in perfect imagery in 20 feet of water over a soft bottom while crappie fishing artificial structures below the boat but may result in excessive noise and distortion resulting from excessive sonar echo energy being received from a hard bottom as the angler moves into shallow water along a rocky shoreline.

What are needed, therefore, are a sonar system, method, and components therefor that adapt to the changing physical environment and fishing profiles desired by an angler without having to physically reposition the transducer housing so as to eliminate or reduce sonar image distortion caused by such changes. Embodiments of the invention provide such a sonar system, method, and components therefor. These and other advantages of the invention, as well as additional inventive features, will be apparent from the description of the invention provided herein.

### BRIEF SUMMARY OF THE INVENTION

In view of the above, embodiments of the present invention provide new and improved sonar systems, methods, and components therefor. Certain embodiments provide such new and improved sonar systems, methods, and components therefor that allow adaptation to the changing physical environment and fishing profiles desired by an angler without having to physically reposition the transducer housing so as to eliminate or reduce sonar image distortion caused by such changes.

In one aspect, certain embodiments of the invention provide a system and method to change the ensonification cone sonar energy distribution to adapt to such changes in environment without the need to reposition the physical transducer housing. In one embodiment the angler selects the sonar energy distribution based on desired display characteristics. In another embodiment, the sonar energy distribution is automatically adjusted based on depth, bottom hardness, water column characteristics, presence of vegetation, etc.

In another aspect, a unique feature of various embodiments is that the sonar system and method are used in different mounting positions where having different beam angles and power levels for each beam are beneficial to operation. Such systems and methods benefit from the use of the variable transmit power automatically based on the returns of the different beams for all the various reflection causes discussed herein, e.g., strong direct reflections in Forward and Down mode, weaker backscatter reflections in Forward and Landscape mode.

In certain embodiments utilizing a plurality of electrode segments to energize different portions of the TX sonar element, power to each electrode segment is independently controlled to provide the desired sonar energy distribution in the ensonification cone. In other embodiments, a change in power to one electrode segment will result in or be controlled to provide a corresponding or opposite change in power delivered to another electrode segment or segments. In certain embodiments, the controlled, corresponding, or opposite change in power is of a similar magnitude, independently different magnitude, or within a controlled ratio of magnitudes between and/or among the electrode segments.

In certain embodiments, the resultant or controlled power change in such other electrode segment or segments will occur only when the change in power to the one electrode segment would result in a physical fracture of the TX sonar element absent such resultant or controlled change in power to such other electrode segment or segments.

In one embodiment, the TX sonar element is formed as a curved, preferably ceramic, element. The length of the arc of the curved element is selected to provide a desired sonar beam width of ensonification. In one embodiment particularly useful for recreational fishing, the curved element spans an arc of between about 150° to about 180°. This will result in a sonar beam width that covers the water column from the surface of the water all the way to directly below the boat, and then extending even above the water surface and behind the boat. In certain embodiments, the diameter of the curved element may range from about 1.5″ to about 3″.

In an embodiment, on the radially outside curved surface of the TX sonar element is a single negative (−) electrode, and a plurality of positive (+) electrodes are located on the radially inside curved surface of the TX sonar element. In one embodiment, three transmit elements are formed from the single TX sonar element by separating, cutting, etching, etc. a single (+) electrode on the radially inside curved surface of the TX sonar element in two places to create three (3) (+) electrode segments, one for each of the three resulting transmit elements. In other embodiments, more or fewer separations, cuts, etchings, etc. may be used to produce more or fewer (+) electrode segments, e.g., one separation will provide two (2) (+) electrode segments.

These (+) electrodes form a plurality of separate transmit element portions of the TX sonar element with separate beamwidths. The summation of the individual beam widths of each of these separate portions add up to about 150° to about 180° depending on the arc length of the TX sonar element. The separate elements are powered in one embodiment with unique power levels based on the conditions in which the angler is fishing.

In an embodiment, a transducer for a consumer sonar fishfinder includes a curved monolithic ceramic element, a segmented electrode positioned on a radially inward facing concave surface of the curved monolithic ceramic element, and a single electrode of polarity opposite the segmented electrode. The single electrode is positioned on a radially outward facing convex surface of the curved monolithic ceramic element.

In an embodiment, the segmented electrode includes a first electrode and a second electrode having a separator posited therebetween. In certain embodiments, the separator is defined by a cut, an etch, or a discontinuity in the segmented electrode. In some embodiments, the separator includes an electrically insulating material positioned therein. In other embodiments, the separator includes an area of no electrical conductivity of a width sufficient to prevent power coupled to one of a first electrode or second electrode from affecting power coupled to the other of the first electrode or second electrode.

In an embodiment, the separator is positioned at an angle along the radially inward facing concave surface of the curved monolithic ceramic element such that a first arc length of the first electrode and a second arc length of the second electrode are equal. In other embodiments, the separator is positioned at an angle along the radially inward facing concave surface of the curved monolithic ceramic element such that a first arc length of the first electrode and a second arc length of the second electrode are unequal.

In an embodiment, the segmented electrode includes a first electrode, a second electrode, and a third electrode. The first electrode and the second electrode have a first separator posited therebetween, and the second electrode and the third electrode have a second separator posited therebetween.

In certain embodiments, the first separator is positioned at a first angle along the radially inward facing concave surface of the curved monolithic ceramic element, and the second separator is positioned at a second angle along the radially inward facing concave surface of the curved monolithic ceramic element. The first angle and the second angle are selected such that a first arc length of the first electrode, a second arc length of the second electrode, and a third arc length of the third electrode are equal to one another.

In another embodiment, the first separator is positioned at a first angle along the radially inward facing concave surface of the curved monolithic ceramic element, and the second separator is positioned at a second angle along the radially inward facing concave surface of the curved monolithic ceramic element. The first angle and the second angle are selected such that a first arc length of the first electrode, a second arc length of the second electrode, and a third arc length of the third electrode are unequal one another.

In yet another embodiment, the first separator is positioned at a first angle along the radially inward facing concave surface of the curved monolithic ceramic element, and the second separator is positioned at a second angle along the radially inward facing concave surface of the curved monolithic ceramic element. The first angle and the second angle are selected such that at least two of a first arc length of the first electrode, a second arc length of the positive electrode, and a third arc length of the third electrode are equal to one another.

In an embodiment, the curved monolithic ceramic element spans an arc of about 150°. The first separator is positioned at a first angle along the arc and the second separator is positioned at a second angle along the arc such that the first electrode spans about 40°, the second electrode spans about 70°, and the third electrode spans about 40°.

In another embodiment, the curved monolithic ceramic element spans an arc of about 150°, and the first separator is positioned at a first angle along the arc and the second separator is positioned at a second angle along the arc such that the first electrode spans about 50°, the second electrode spans about 50°, and the third electrode spans about 50°.

In a further embodiment, the curved monolithic ceramic element spans an arc of about 150°, and the first separator is positioned at a first angle along the arc and the second separator is positioned at a second angle along the arc such that the first electrode spans about 60°, the second electrode spans about 40°, and the third electrode spans about 50°.

I an embodiment, the transducer includes a first sonar power transmitter operatively coupled to the first electrode, a second sonar power transmitter operatively coupled to the second electrode, and a third sonar power transmitter operatively coupled to the third electrode. The first sonar power transmitter, the second sonar power transmitter, and the third sonar power transmitter each provide individual beam amplitude control for the first electrode, the second electrode, and the third electrode, respectively.

In another embodiment, the transducer includes a single sonar power transmitter operatively coupled to the first electrode via a first high voltage variable resistor, to the second electrode via a second high voltage variable resistor, and to the third electrode via a third high voltage variable resistor. The first high voltage variable resistor, the second high voltage variable resistor, and the third high voltage variable resistor divide power among the first electrode, the second electrode, and the third electrode to provide beam amplitude control for the first electrode, the second electrode, and the third electrode.

In an embodiment, the curved monolithic ceramic element spans an arc between about 150° to about 180°.

In an embodiment, the transducer further includes at least one sonar energy absorber positioned within a concave curvature of the curved monolithic ceramic element and an annular element shield housing the curved monolithic ceramic element and the at least one sonar energy absorber therein. In another embodiment, the transducer further includes a backer absorber positioned behind the at least one sonar energy absorber. The at least one energy absorber includes a top absorber, a middle absorber, and a bottom absorber.

In another embodiment, a method to provide directional power distribution of sonar energy using the transducer, wherein the segmented electrode includes a first electrode, a second electrode, and a third electrode, includes the steps of energizing the first electrode at a first power level to cause the curved monolithic ceramic element to transmit an upper sonar beam (U), energizing the second electrode at a second power level to cause the curved monolithic ceramic element to transmit a middle sonar beam (M), and energizing the third electrode at a third power level to cause the curved monolithic ceramic element to transmit a lower sonar beam (L).

In an embodiment, the first power level, the second power level, and the third power level are approximately equal. In another embodiment, the first power level, the second power level, and the third power level are unequal. In yet another embodiment, at least one of the first power level, the second power level, and the third power level is different than at least one other of the first power level, the second power level, and the third power level.

In an embodiment, the steps of energizing include the step of varying a respective power level based on at least one of depth, width, distance to a limiting structure, user settings, grazing angle, and composition.

In another embodiment, the step of energizing the third electrode at the third power level to cause the curved monolithic ceramic element to transmit the lower sonar beam (L) includes the step of varying the third power level based on at least one of depth, width, distance to a limiting structure, user settings, grazing angle, and a bottom composition.

In an embodiment, the step of energizing the first electrode at the first power level to cause the curved monolithic ceramic element to transmit the upper sonar beam (U) includes the step of reducing the first power level to reduce production of ghost images of targets from reflections of sonar energy from a surface of a fishing environment.

In another embodiment, the step of energizing the first electrode at the first power level to cause the curved monolithic ceramic element to transmit the upper sonar beam (U) includes the step of setting the first power level to a medium power level to detect a splash of a jig on a surface of a fishing environment while reducing production of ghost images of targets from reflections of sonar energy from the surface.

In a further embodiment, the step of energizing the second electrode at the second power level to cause the curved monolithic ceramic element to transmit the middle sonar beam (M) includes the step of setting the second power level to a maximum power level to track the jig through a water column of the fishing environment.

In a still further embodiment, the step of energizing the third electrode at the third power level to cause the curved monolithic ceramic element to transmit the lower sonar beam (L) includes the step of setting the second power level to a minimum power level to reduce generation of side lobes when in one of shallow water or over a hard bottom.

In an embodiment, the step of energizing the first electrode at the first power level to cause the curved monolithic ceramic element to transmit the upper sonar beam (U) includes the step of setting the first power level to a minimum power level to reduce production of ghost images of targets from reflections of sonar energy from a surface of a fishing environment. The steps of energizing the second electrode at the second power level to cause the curved monolithic ceramic element to transmit the middle sonar beam (M) and energizing the third electrode at the third power level to cause the curved monolithic ceramic element to transmit the lower sonar beam (L) include the steps of setting respective power levels to a maximum power level to track the jig through a water column of the fishing environment.

In another embodiment, the steps of energizing include the step of limiting a respective power level based on a maximum power level to prevent damage to the curved monolithic ceramic element.

In certain embodiments, the steps of energizing include the step of varying a respective power level automatically based on at least one of sonar return amplitude and pulse elongation criteria caused by at least one of depth, width, distance to a limiting structure, grazing angle, composition, housing orientation.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of a sonar transducer housing for a multibeam phased array sonar system utilizing elements of the present invention;

FIG. 2 is a perspective illustration of the sonar transducer housing of FIG. 1 mounted on a trolling motor shaft in a first orientation;

FIG. 3 is a three-dimensional representation of an ensonification volume in a first fishing environment when the sonar transducer housing of FIG. 1 is mounted in the orientation of FIG. 2;

FIG. 4 is a representative sonar display image generated by an embodiment of the present invention of the first fishing environment of FIG. 3 when the sonar transducer housing of FIG. 1 is mounted in the orientation of FIG. 2;

FIG. 5 is a three-dimensional representation of an ensonification volume in a second fishing environment when the sonar transducer housing of FIG. 1 is mounted in the orientation of FIG. 2;

FIG. 6 is a representative sonar display image generated by an embodiment of the present invention of the second fishing environment of FIG. 5 when the sonar transducer housing of FIG. 1 is mounted in the orientation of FIG. 2;

FIG. 7 is a perspective illustration of the sonar transducer housing of FIG. 1 mounted on a trolling motor shaft in a second orientation;

FIG. 8 is a three-dimensional representation of an ensonification volume in the first fishing environment when the sonar transducer housing of FIG. 1 is mounted in the orientation of FIG. 7;

FIG. 9 is a representative sonar display image generated by an embodiment of the present invention of the first fishing environment of FIG. 8 when the sonar transducer housing of FIG. 1 is mounted in the orientation of FIG. 7;

FIG. 10 is a three-dimensional representation of an ensonification volume in the second fishing environment when the sonar transducer housing of FIG. 1 is mounted in the orientation of FIG. 7;

FIG. 11 is a representative sonar display image generated by an embodiment of the present invention of the second fishing environment of FIG. 10 when the sonar transducer housing of FIG. 1 is mounted in the orientation of FIG. 7;

FIG. 12 is a perspective illustration of the sonar transducer housing of FIG. 1 mounted on a trolling motor shaft in a third orientation;

FIG. 13 is a three-dimensional representation of an ensonification volume in a third fishing environment when the sonar transducer housing of FIG. 1 is mounted in the orientation of FIG. 12;

FIG. 14 is a representative sonar display image generated by an embodiment of the present invention of the third fishing environment of FIG. 13 when the sonar transducer housing of FIG. 1 is mounted in the orientation of FIG. 12;

FIG. 15 is a three-dimensional representation of an ensonification volume in a fourth fishing environment when the sonar transducer housing of FIG. 1 is mounted in the orientation of FIG. 12;

FIG. 16 is a representative sonar display image generated by an embodiment of the present invention of the fourth fishing environment of FIG. 15 when the sonar transducer housing of FIG. 1 is mounted in the orientation of FIG. 12;

FIG. 17 is a perspective illustration of a TX sonar element constructed in accordance with an embodiment of the present invention;

FIG. 18 is a perspective illustration of a TX sonar element constructed in accordance with an embodiment of the present invention;

FIG. 19 is a perspective illustration of a TX sonar element constructed in accordance with an embodiment of the present invention;

FIG. 20 is a top view of the TX sonar element constructed in accordance with an embodiment illustrated in FIG. 17;

FIG. 21 is a top view of the TX sonar element constructed in accordance with an embodiment illustrated in FIG. 18;

FIG. 22 is a top view of the TX sonar element constructed in accordance with an embodiment illustrated in FIG. 19;

FIG. 23 is an exploded view of a TX transducer assembly constructed in accordance with an embodiment of the present invention;

FIG. 24 is a top view of an assembled TX transducer assembly of FIG. 23;

FIG. 25 is a perspective view of the TX transducer assembly of FIG. 24;

FIG. 26 is a simplified schematic block diagram of an embodiment of a TX transducer driver circuit having individual transmitters for each segment of the TX sonar element; and

FIG. 27 is a simplified schematic block diagram of an embodiment of a TX transducer driver circuit having a single transmitter supplying power through individual variable resistors to each segment of the TX sonar element.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Turning now to the drawings, there are illustrated various embodiments of the present invention as well as operational scenarios and environments in which the various embodiments find particular applicability. The discussion of same is provided in order to teach those of skill in the art how to make and use the invention, as well as the breadth and scope of the invention as evidenced from the various embodiments discussed herein. However, such discussion of various embodiments should be taken by way of example and not by way of limitation.

Turning then to FIG. 1, there is illustrated an embodiment of a transducer assembly 100 constructed in accordance with an embodiment of the present invention. Specifically, the transducer assembly 100 includes a housing 102 that is configured to provide a transmit (XMT) transducer window 104 and a receive (RCV) array window 106. These windows 104, 106 may be made of acoustically transparent materials that may differ from or be the same as the materials utilized in the construction of the housing 102.

As illustrated in the embodiment of FIG. 1, the transducer assembly 100 also includes a mounting bracket 108 to allow the transducer assembly 100 to be mounted to, e.g., a trolling motor shaft, a dedicated transducer mounting shaft, or other structure to enable deployment of the transducer assembly 100 in the aquatic environment. Indeed, and as will be discussed more fully below, the particular configuration of the mounting bracket 108 may allow for such deployment in various orientations to provide functionally distinct operating modes depending on the fishing situation and set up desired by the angler.

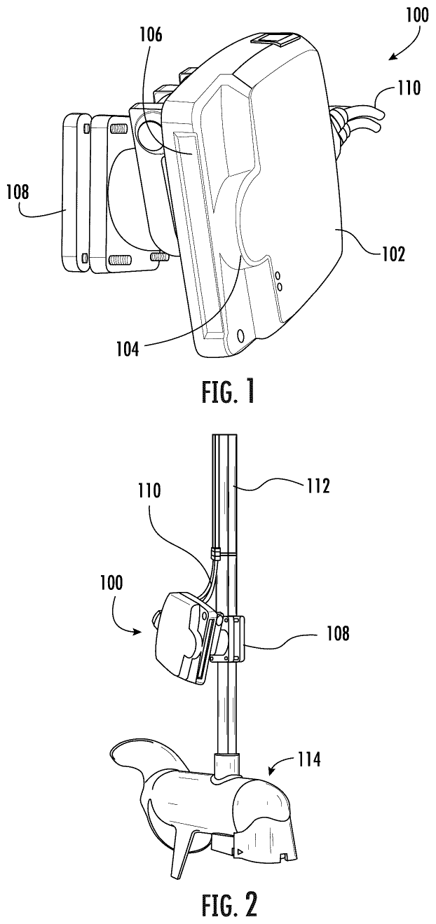

FIG. 2 illustrates one such deployment wherein the transducer assembly 100 and its power and communications cabling 110 are mounted via the mounting bracket 108 onto a pole 112 of a trolling motor 114. In the particular orientation shown in FIG. 2, referred to as forward-looking, the transducer assembly 100 is directed forward and downward in alignment with the steering axis of the trolling motor 114. Indeed, in such a mounting configuration, the transducer assembly 100 may be steered by using the trolling motor steering controls so that the sonar images produced correlate with the steering direction of the trolling motor 114 itself.

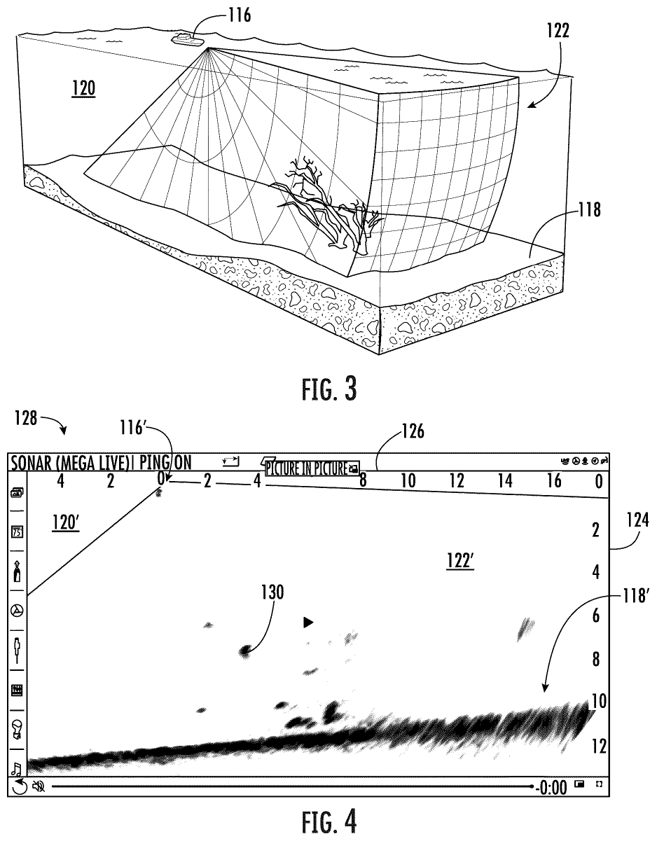

FIG. 3 provides a three-dimensional representation of an ensonification volume of a first aquatic fishing environment corresponding to the mounting orientation of the transducer assembly 100 as shown in FIG. 2. In this illustration the fishing boat 116 is shown as the point of orientation of the ensonification cone 122 through the water column 120 in this particular fishing environment. The ensonification cone 122 is illustrated as emanating through the water column 120 to the bottom 118 in this environment.

FIG. 4 illustrates a representative sonar image corresponding to the mounting orientation of the sonar assembly 100 shown in FIG. 2 for the fishing environment shown in FIG. 3. As may be seen in the sonar display 128, the fishing boat representation 116′ appears at the origin of the ensonification cone 122′ representation through the water column 120′ representation. The bottom 118′ representation may also be seen, as can various targets 130 (e.g., fish). The sonar display 128 also includes a depth axis 124 and a distance axis 126 to provide the angler with information allowing the angler to more easily cast in a manner to catch the fish (target 130).

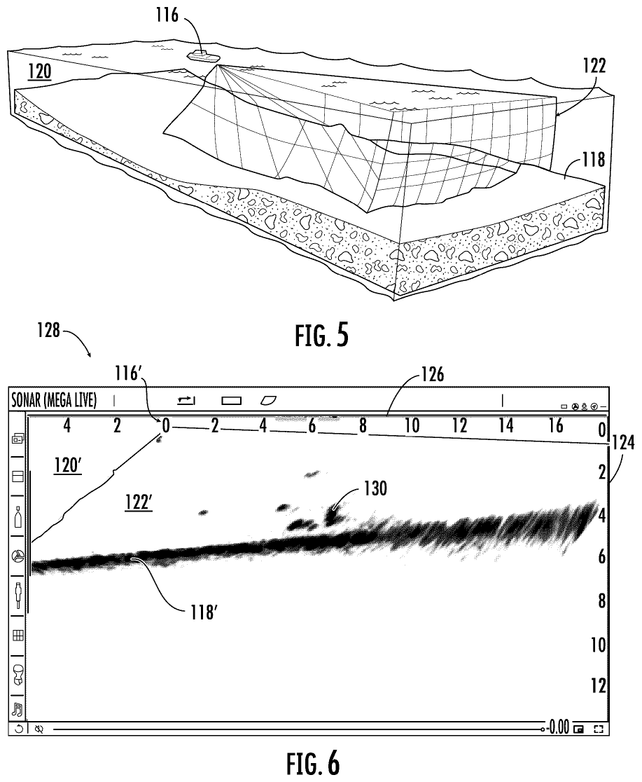

In such a fishing environment as shown in FIG. 3, the power used to generate the ensonification cone 122 may be uniformly distributed in view of the volume of the water column 120 both in front of and below the fishing boat 116. However, as the fishing boat 116 moves into shallower water as shown in FIG. 5, sonar reflections from the bottom would tend to overwhelm the sonar display system if the same transmit power were utilized for the downward facing portion of the transducer assembly 100.

As such, and as will be discussed more fully below, the power distribution throughout the ensonification cone 122 in accordance with embodiments of the present invention is adjusted such that less power is provided to the downward facing portion of the transducer assembly 100. Indeed, the amount of power necessary to effectively transmit ensonification pulses over such a short distance is much lower than that for the forward-looking portions of the transducer assembly 100 that still must traverse the angler selected distance in front of the boat.

When properly adjusted in accordance with the teachings of various embodiments of the present invention, a very clean sonar display such as shown in FIG. 6 is achieved that properly resolves and displays the targets 130, even when close to the bottom 118′ in the shallow environment.

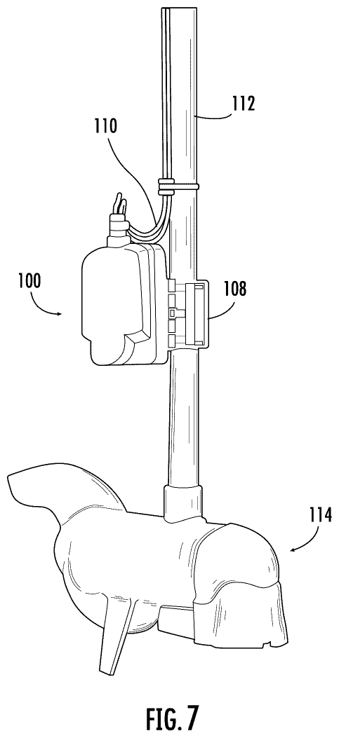

As mentioned previously, the mounting bracket 108 is configured such that the transducer assembly 100 may be oriented to provide different modes of operation. In FIG. 7 the transducer assembly 100 is oriented to face downward to provide a down operating mode. When in this orientation the ensonification cone 122 through the water column 120 begins at the fishing boat 116 and fans out directly below to the bottom 118. Because of the curved nature of the transducer of embodiments of the present invention, this ensonification cone 122 fans out both in front and behind, or to both the left and right side, of the fishing boat depending on the angle of rotation or mounting direction of the transducer assembly 100 compared to the keel of the boat.

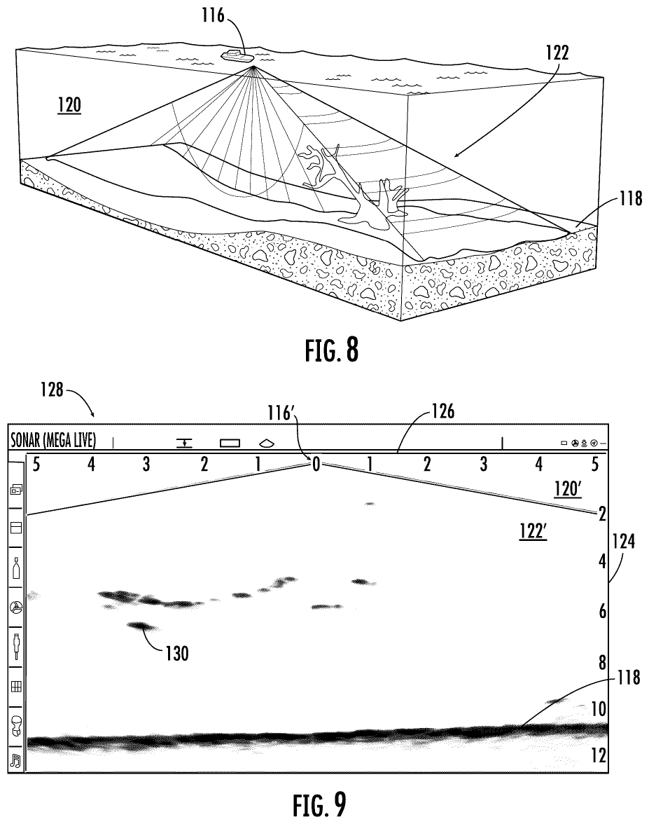

FIG. 9 provides a representative sonar display 128 when utilizing the down operating mode with the transducer assembly 100 in the orientation shown in FIG. 7 while operating in the environment shown in FIG. 8.

When operating in such an environment as shown in FIG. 8 in this down mode of operation, the power distribution throughout the ensonification cone 122 may be uniform in one embodiment. That is, the same amount of power may be applied to each of the portions or segments of the transmit transducer (to be discussed more fully below) because the transmission and return path of the sonar pulses generated therein are similar. While the total power distributed throughout the ensonification cone 122 may vary based upon the depth and width of the environment, or of those desired to be ensonified by the angler, the distribution through the various angular portions generated by power application to the various segments of the transmit transducer itself may be uniform in this embodiment.

In another embodiment operating in this down mode, the power distribution throughout the ensonification cone 122 may be varied. Such variation is based on a recognition that the center portion of the transmit element that is pointing straight down is going to have stronger returns because most of the energy is going to reflect back. Returns from the front and back portions of the ensonification cone 122 will have weaker returns because they are at a greater grazing angle to the bottom, and, therefore, more of the echo energy will be reflected away, regardless of depth. As such, an embodiment may vary the power distribution throughout the ensonification cone 122 so the total transmit strength will vary with depth, but also with angle of the front and back portions such that they are always be a bit stronger than the portion of the ensonification cone 122 directed straight down.

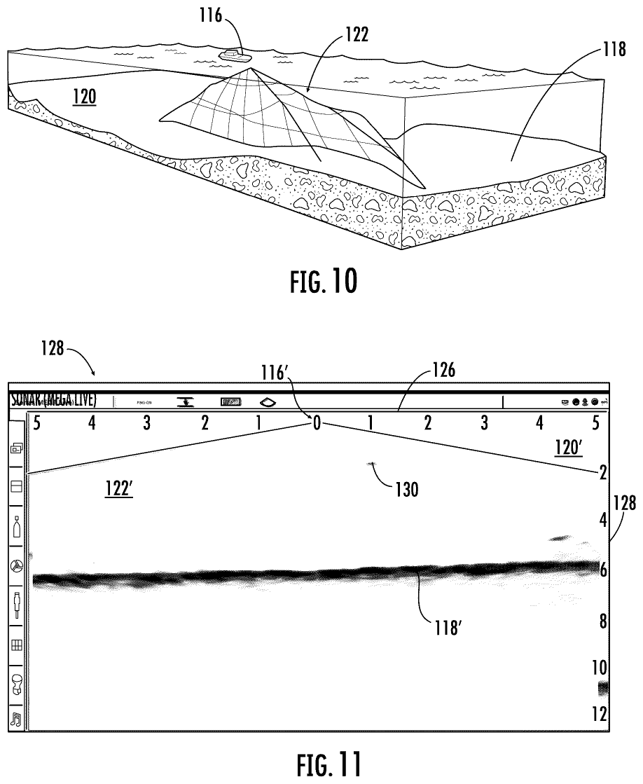

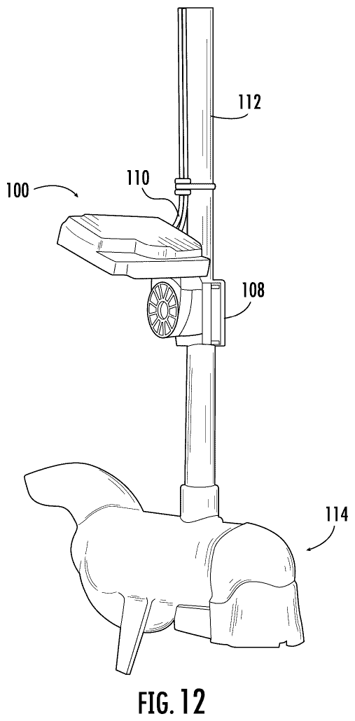

However, as the fishing boat 116 moves into shallower water as illustrated in the representation of FIG. 10, the power distribution through the much smaller ensonification cone 122 may now be varied based on the shorter distance to the bottom 118 directly below the fishing boat 116. Because supplying the same amount of power to the downward facing portion of the transmit transducer that was used in a deep fishing environment would result in possible distortion of the sonar image due to the side lobes generated by such strong returns, the downward facing portions of the transmit transducer are energized with lower power as appropriate for such short transmit and return paths. However, because the angler may wish to maintain the distance fore and aft, or port and starboard, of the fishing boat 116 in the ensonification cone 122, power to the end portions of the transmit transducer may be maintained at their previous levels, in either of the preceding embodiments, in order to cover this longer distance and/or greater angle.

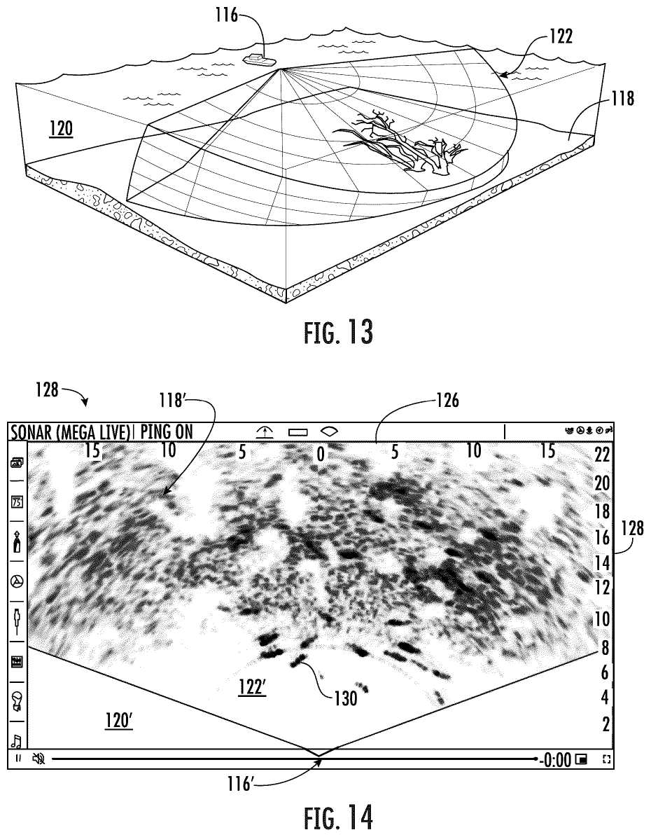

A third possible orientation provided by the mounting bracket 108 of the transducer assembly 100 is shown in FIG. 12. In this landscape orientation, the ensonification cone 122 fans out in front of the fishing boat 116 in a manner illustrated in FIG. 13. When used in such a fishing environment, the sonar display 128 may appear as shown in FIG. 14. Because the sonar imaging is for a landscaped portion in front of the boat, the sonar image 128 illustrates the fishing boat 116 at the bottom of the display as may be seen in FIG. 14 as opposed to the top of the display in the prior two operating modes.

When utilizing the landscape mode of operation in open water such as illustrated in FIG. 13, the power distribution throughout the ensonification cone 122 may be uniform. That is, the imaging area provided by the ensonification cone 122 in such an open water environment is limited only to the range selected by the angler, and, as illustrated, is a uniform distance throughout the ensonification cone 122. While the total amount of power used to generate the ensonification cone 122 may be varied based upon the desired range of the imaging, in such an open environment there is no need to vary the distribution of such power among the various angular portions thereof in one embodiment.

In another embodiment operating in this landscape mode of operation, the power distribution throughout the ensonification cone 122 may be varied. Such variation is based on a recognition that the center portion of the transmit element that is pointing straight forward is going to have stronger returns because most of the energy is going to reflect back from a target. Returns from the right and left portions of the ensonification cone 122 will have weaker returns because they are at a greater grazing angle, and, therefore, more of the echo energy will be reflected away or will be received at a greater angle, regardless of distance. As such, an embodiment may vary the power distribution throughout the ensonification cone 122 so the total transmit strength will vary with distance, but also with angle of the right and left portions such that they are always be a bit stronger than the portion of the ensonification cone 122 directed straight forward.

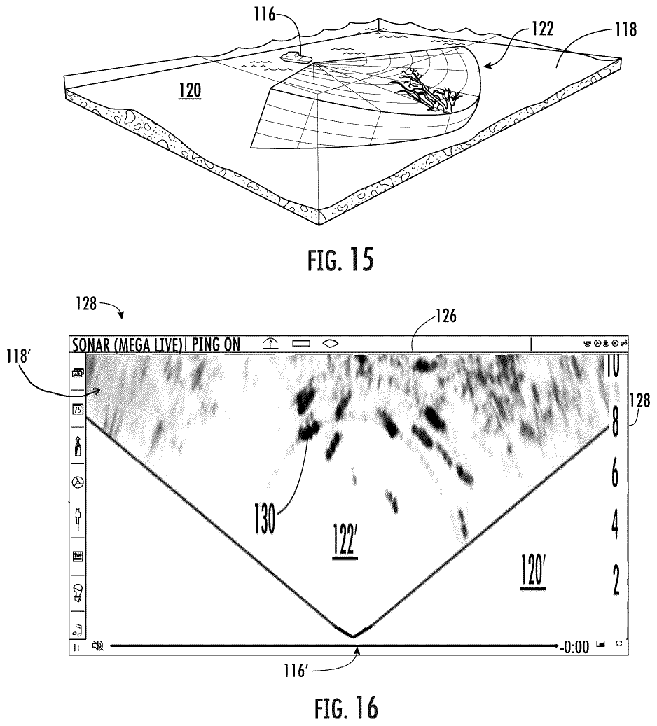

However, if the fishing boat 116 were to approach a shoreline as illustrated in FIG. 15, or a rock wall or other forward distance limiting structure, the reduced travel distance of the sonar pings in the ensonification cone 122 would again produce undue distortion if the same uniform power distribution as just discussed in open water were used. As such, embodiments of the present invention reduce the amount of power provided to the directly-forward-facing portions of the transmit transducer in view of the substantially reduced transmission and return distance from the fishing boat 116 to the limiting structure, e.g., a shoreline, rock wall, dam, etc. However, while the forward distance may be limited by such structure, the distance on either side of the fishing boat 116 may still utilize the higher power levels to properly image such areas in the ensonification cone 122. A representative sonar display 128 of such a situation may be seen in FIG. 16.

Further, in another embodiment it is also recognized that the shoreline, rock wall, dam, etc. may be encountered on either the left or right side of the boat (or at any angle to the boat) that would reduce the travel distance of the sonar pings in the ensonification cone 122 and that would again produce undue distortion if the same power distribution as just discussed were used. As such, certain embodiments of the present invention reduce the amount of power provided to the distance-limiting-structure-facing portions of the transmit transducer in view of the substantially reduced transmission and return distance from the fishing boat 116 to the limiting structure, e.g., a shoreline, rock wall, dam, etc. However, while the distance may be limited by such structure in that portion of the ensonification cone 122, the distances encountered in other regions of the ensonification cone 122 away from such structure may still utilize the higher power levels to properly image such areas in the ensonification cone 122.

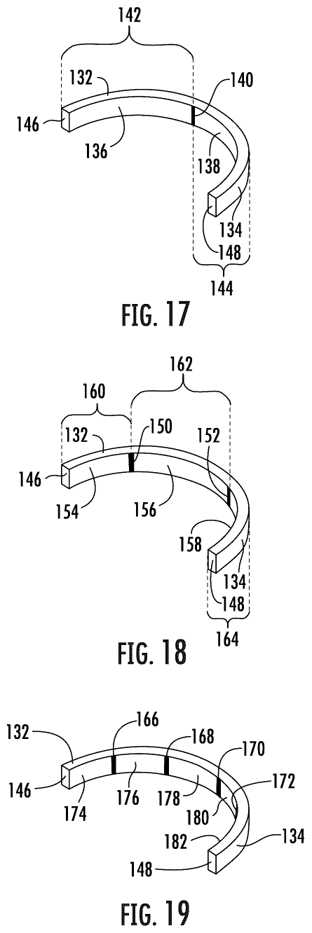

In order to provide the proper sonar imaging of the various aquatic environments for each of the available operating modes discussed above, a curved monolithic transducer 132, such as illustrated in FIG. 17, may be utilized. As is typical with the use of such curved monolithic transducers 132, a negative electrode 134 is formed or affixed on the radially outward facing surface thereof. However, unlike traditional curved transducers, the embodiment illustrated in FIG. 17 utilizes a first positive electrode 136 and a second positive electrode 138 on the radially inner facing surface of the curved monolithic transducer 132.

Prior curved transducers only utilized a single positive electrode that spanned the entire length of the curved transducer, and therefore could only produce an ensonification cone of uniform power distribution throughout. However, in the embodiment of the present invention shown in FIG. 17, the power provided to the first positive electrode 136 and to the second positive electrode 138 may be individually controlled to provide differing power distribution into halves of the ensonification cone generated thereby.

As illustrated in FIG. 17, a separator 140, which may be a cut, etch, or other discontinuity electrically separates the first positive electrode 136 from the second positive electrode 138. The separator 140 may be constructed with a dielectric or other electrically insulating material or may simply be an area of no electric conductivity of a width sufficient to prevent power delivered to one electrode from affecting the power to the other.

With such a construction, the curved monolithic transducer 132 provides a first segment 142 and a second segment 144 that may be individually powered to produce portions of the ensonification cone at different power levels. As may be seen, the first segment 142 is formed between the first end 146 of the curved monolithic transducer 132 and the separator 140, while the second segment 144 exists between the second end 148 and the separator 140. The separator 140 may be positioned at any angular location, e.g., 90°, 40°, etc., depending on the desired division between the resulting two segments 142, 144. In such an embodiment, one of the segments, e.g. an upper segment in a forward mode orientation, could simply be turned off to prevent any reflected energy from the surface that otherwise may produce “ghost” images of targets in the water and on the bottom.

In the embodiment illustrated in FIG. 18, two separators 150, 152 are utilized to provide a first positive electrode 154, a second positive electrode 156, and a third positive electrode 158. These three positive electrodes 154, 156, 158, result in a curved monolithic transducer 132 having a first segment 160, a second segment 162, and a third segment 164 that may be individually energized in order to produce an ensonification cone that may have a varying power distribution in each of the three portions generated thereby.

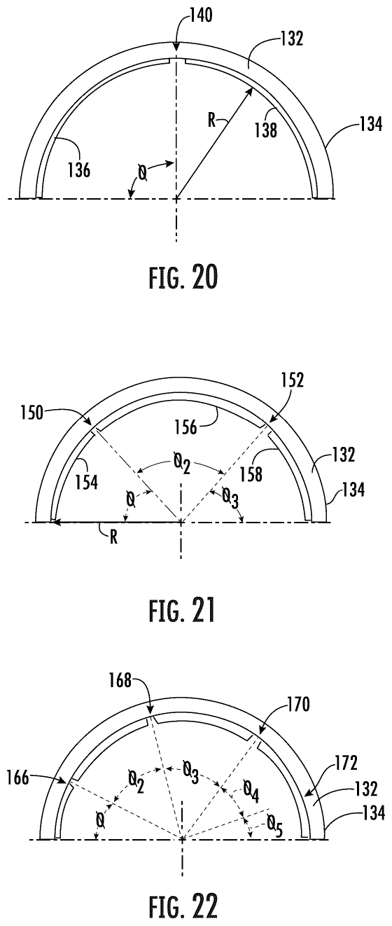

In the embodiment shown in FIG. 19, separators 166, 168, 170, and 172 are utilized to produce a plurality of positive electrodes 174, 176, 178, 180, 182. As with the previous embodiments, each of these individual positive electrodes may be individually energized to control the power within each of the resulting segments of the ensonification cone. Indeed, as this embodiment illustrates, the number of positive electrodes may very as desired in order to provide customized power distribution across the ensonification cone.

A top view of the transducer embodiment of FIG. 17 may be seen from the illustration of FIG. 20. The radius R of the curved monolithic transducer 132 is illustrated and may range from approximately 1.5 inches to three inches for embodiments utilized in typical recreational fishing. However, the radius R may be varied depending on the particular application, power levels as desired, etc.

Further, while FIG. 20 illustrates the angle Φ from the end of the curved transducer to the separator 140 as being 90° to provide equal arc length of the first positive electrode 136 and the second positive electrode 138, other embodiments may vary this angle Φ so as to provide a different arc length for each of the two positive electrodes 136, 138. Such different arc lengths provide different sized segments that can be used to deliver individually controlled power levels in different portions of the ensonification cone that may be configured for particular applications.

Indeed, similar adjustments can be made to the angles Φ, Φ₂, Φ₃ shown in FIG. 21 corresponding to the embodiment of FIG. 18, and to the angles Φ, Φ₂, Φ₃, Φ₄, Φ₅ in FIG. 22 corresponding to the embodiment of FIG. 19 to also provide different sized segments to produce customized power distribution ensonification cones. While not dependent upon the type of mounting bracket or deployment mechanism used with the sonar transducer assembly of the present invention, such customized segments find particular applicability in fixed deployment embodiments and particular environments to provide the maximum resolution and ensure complete ensonification of the areas of interest to the angler, researcher, etc.

While the embodiments illustrated in FIGS. 17-22 span a full semi-circle of 180°, other embodiments of the present invention utilize a total arc length of the curved monolithic transducer 132 that is greater or less than 180° to provide a greater or lesser span of the ensonification cone. One such embodiment utilizes a curved monolithic transducer 132 of 150° span from one end to the other. Preferably, such embodiment is symmetrical about the midpoint of the curved monolithic transducer 132, to wit, a reduction of 15° on each end of the transducer from the otherwise semicircular 180° embodiment. However, in other embodiments the length of curvature is not symmetrical about the midpoint.

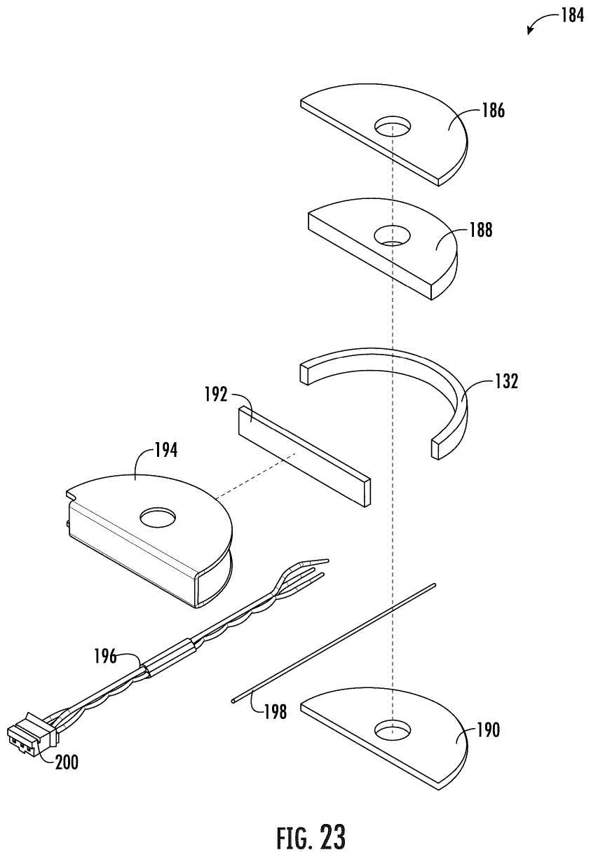

FIG. 23 illustrates an exploded view of the transmit transducer assembly 184. As may be seen, a top absorber 186 and a bottom absorber 190 are used on the top and bottom of a middle absorber 188. These three absorbers 186, 188, 190 are positioned within the concave curvature of the curved monolithic transducer 132 to provide attenuation of any sonar energy on the back side of the curved monolithic transducer 132. A backer absorber 192 is also utilized behind these absorbers 186-190.

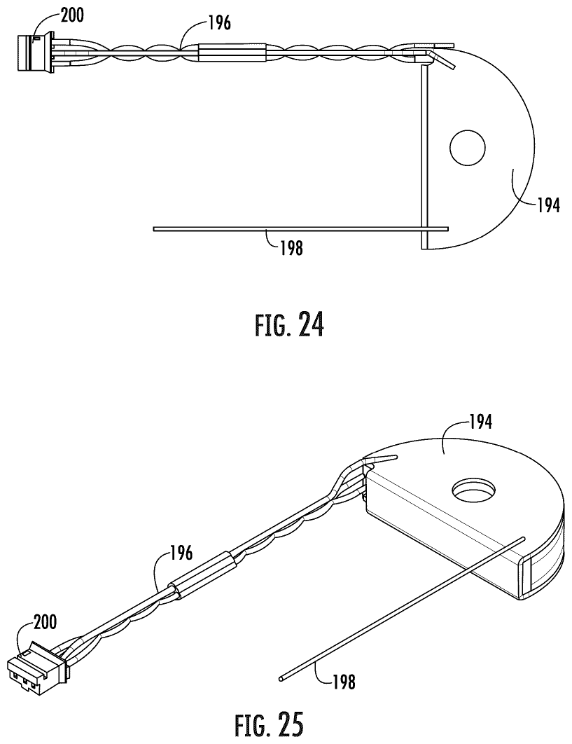

An annular element shield 194 is also utilized to limit the erroneous transmission of sonar energy behind, above, and below the curved monolithic transducer 132. A wire harness cable 196 and buss wire 198 are also utilized in the transmit transducer assembly 184. The number of wires in the wire harness 196 varies depending on the number of positive electrodes utilized in various embodiments so that power may be delivered to each such individual positive electrode via a separate wire. The wire harness cable 196 terminates in a connector 200 that may be mated to an output connector of a power or control board for the transducer. FIG. 24 provides a top view and FIG. 25 provides a perspective view from which the assembled curved monolithic transducer, the absorbers, and the shield may be seen in relation to one another.

With the foregoing embodiments, orientations, and environments in mind, the following will provide a more detailed description of the construction and power application that may be used in embodiments of the present invention having three electrode segments such as shown in FIGS. 18 and 21. In this discussion, the following convention will be used when the sonar transducer housing is oriented in forward mode as shown in FIG. 2, to wit, the sonar beam that travels out in front of the boat beginning at the surface of the water and extending down from there will be referred to as the UPPER beam (U); the beam that goes straight down to the bottom directly under the boat and extends upward from there will be referred to as the LOWER beam (L); and the beam in between the U and L beams will be referred to as the MIDDLE beam (M). The U, M, and L beams make up the ensonification cone 122.

Of course, those skilled in the art will recognize that some of the transmit energy in the U beam in the forward mode may go above the waterline. Indeed, this is one of the reasons to have the segmented transmit element of embodiments of the present invention. As discussed herein, the energy of the U beam is controlled so that the reflected energy from the surface that produces “ghost” images of targets in the water and on the bottom can be minimized. To have the wide area of coverage in the Down and Landscape views, embodiments ensonify the full range of coverage by the transducer, e.g., 150 to 180 degrees of coverage in certain embodiments. While the angle of the transducer in the Forward view could be adjusted so that top segment just skims the surface of the water, such a physical orientation would provide significant interfering returns from the back of the boat from the bottom segment. In either orientation, therefore, the power to either the top or bottom element would need to be reduced to account for this. Therefore, it should be recognized that stating that the U beam “begins at the surface of the water” is but a convenient convention. Indeed, in some implementations of beam arc length and Forward mode elevation angle, where the M beam will include the water surface, the U beam may then be muted completely for Forward mode operation.

In one embodiment wherein the arc length of the curved monolithic transducer 132 is 150°, the (+) electrode 154, 156, 158 size, arc length, and resulting sonar beam width for each portion of the curved monolithic transducer 132 are chosen such that U=40°, M=70°, and L=40°. In another embodiment the (+) electrode 154, 156, 158 size, arc length, and resulting sonar beam width for each portion of the TX sonar element are chosen such that U=M=L=50°. In still another embodiment the (+) electrode 154, 156, 158 size, arc length, and resulting sonar beam width for each portion of the TX sonar element are chosen such that U=60°, M=40°, and L=50°. Other combinations of (+) electrode 154, 156, 158 size are also possible and provide ensonification coverage from these three beams of 150° which coverage is particularly well suited for recreational fishing.

In addition to controlling the physical size of each (+) electrode 154, 156, 158, and therefore the resulting sonar beam width generated therefrom, the amplitude or the amount of power provided to each of these positive electrodes 154, 156, 158 is controlled, in embodiments of the present invention, based on various factors apparent in different fishing scenarios.

In one fishing scenario wherein the angler is in shallow water, e.g. 10 feet deep, and is casting a jig 100 feet out in front of the boat, which is a very common situation during, e.g., bass fishing, a medium amount of power is provided to the (+) electrode (154 or 158 depending on orientation) to generate the U beam. Such medium power for the U beam provides good resolution to show the splash of the jig upon contact with the water surface without producing a lot of surface return noise that would typically occur in prior systems that provided uniform power across the entire ensonification cone.

A maximum amount of power is used in this scenario for the (+) electrode 156 used to produce the M beam to track the jig through the water column at such a casting distance. Finally, a minimum amount of power is provided to the (+) electrode (158 or 154 depending on orientation) that produces the L beam, which reduces the side lobes that would otherwise be generated in prior uniform power transducers from the sonar pulse pounding into the bottom in such shallow water or a hard bottom.

In a different scenario, but still utilizing the sonar transducer housing 102 oriented in the forward mode, wherein the angler is fishing in very deep water and wants to just flip the jig out 30 feet and let it drop, the power to the (+) electrode (154 or 158 depending on orientation) to generate the U beam is minimized to minimize surface clutter and delayed “ghost” echoes on the display. This is allowable because the sonar system does not need a lot of power to track a jig ~30 feet out in front of the boat. However, in such deep water the system applies a maximum amount of power to the (+) electrodes 156 and 158 or 154 depending on orientation that generate the M and L beams to track the jig to such deeper depths.

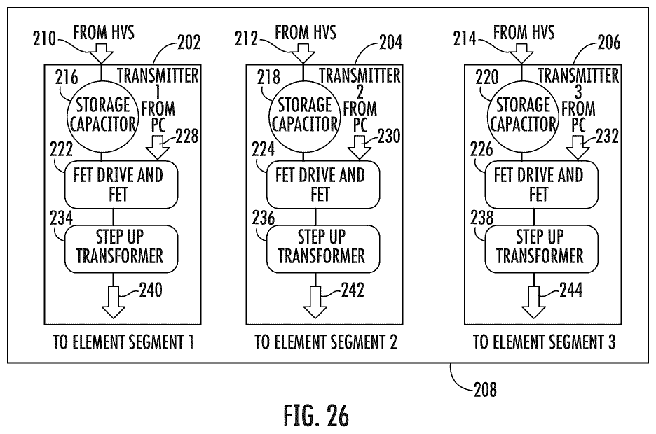

In order to supply independently controllable power to each of the individual (+) electrodes 154, 156, 158, one embodiment utilizes separate sonar power transmitters 202, 204, 206 on the printed circuit board (PCB) 208 as shown in FIG. 26. Each of the separate sonar power transmitters 202, 204, 206 are coupled 210, 212, 214 to a high voltage power supply to charge a storage capacitor 216, 218, 220. A field-effect transistor (FET) 222, 224, 226, individually driven by a control input 228, 230, 232 from a process controller, is coupled through a step-up transformer 234, 236, 238 to the output 240, 242, 244 that is coupled to an associated (+) electrode of the individual segments of the TX element. In such an embodiment, adjusting power to, e.g., two of the three (+) electrodes supplied from two of the three sonar power transmitters, e.g., 202, 204 has no effect on the power supplied to the third (+) electrode from the third sonar power transmitter, e.g., 206. In such an embodiment individual beam amplitude control is provided.

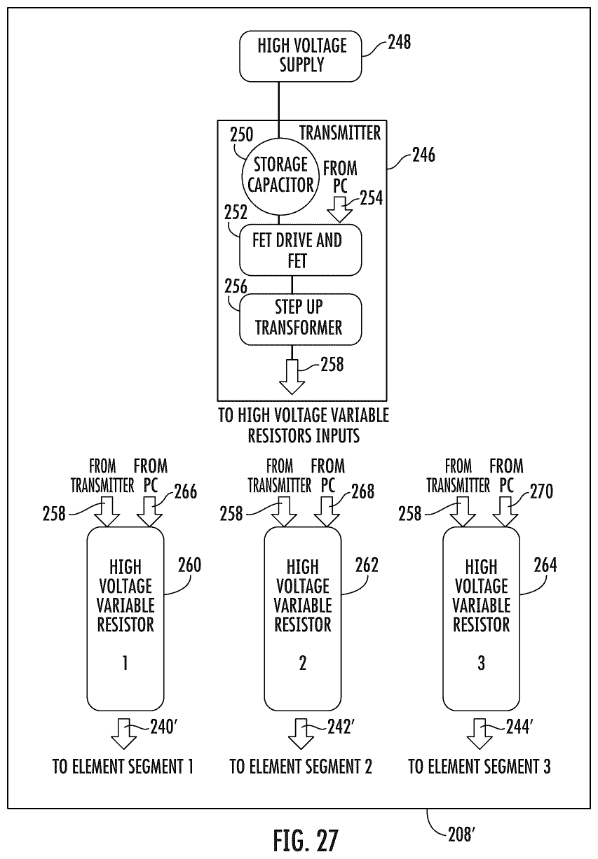

In another embodiment as shown in FIG. 27, only a single sonar power transmitter 246 on the PCB 208′ is used to supply power to all of the (+) electrodes on the sonar TX element. The sonar power transmitter 246 is coupled to the high voltage power supply 248, and includes a storage capacitor 250, a FET and FET drive 252 controlled by a control input 254 from the process controller, and a step-up transformer 256. The output 258 is coupled to each of the high voltage variable resistors 260, 262, 264, the resistance of which are controlled by an input 266, 268, 270 from the process controller. The output 240′, 242′, 244′ of each of the variable resistors 260, 262, 264 is coupled to an associated (+) electrode of the individual segments of the TX element.

Power division between the, e.g., three (+) electrodes 154, 156, 158, is provided through this variable resistance network of the high voltage variable resistors 260, 262, 264. In such an embodiment care must be taken to prevent damage to the sonar TX element. For example, in the situation where power to two of the (+) electrodes is reduced to a low level, all of the remaining power from the single sonar power transmitter 246 will be provided to the third (+) electrode. Such unchecked power disparity across the sonar TX element may resulting in physical damage due to the stresses introduced therein.

As such, in embodiments that utilize a single sonar power transmitter 246 to supply power to each segmented transmit element (+) electrode through variable resistance networks or other means, the amount of power going into each segment it taken into consideration in the overall power delivery. For example, in one embodiment when a significant percentage, e.g., 2 out of 3 elements, are reduced in power, which would result in the remaining segment experiencing a significant increase in available power that may lead to damage to that segment and the sonar TX element as a whole as just discussed, the power supplied by the single sonar power transmitter 246 is itself decreased. This decrease in the single transmitter's output 258 power will ensure that the total power supplied to the other (+) electrode is below a level that would otherwise result in the damage just discussed. That level may vary based on the particular material used to construct the sonar TX element as well as the physical size of the sonar TX element and the portion associated with each of the (+) electrodes used thereon.

Regardless of the sonar power transmitter configuration used, embodiments of the present invention generate the sonar pings with the maximum safe transmit power to improve signal to noise ratio. However, because embodiments of the present invention may be deployed in different orientations to provide different sonar modes as shown, e.g., in FIGS. 2, 7, and 12 for forward, down, and landscape modes, respectively, embodiments of the present invention adjust the power to each segment to vary the characteristics of the transmit beamwidth for these different modes.

In one embodiment, the upper third of the beam, i.e., the U beam, is not produced (or may be reduced) in forward mode when jig contact with the water surface is not a concern because much of the U beam bounces off the surface and generates unwanted sonar information, e.g., the delayed “ghost” echoes of targets in the water and on the bottom. When in such mode over a hard bottom, an embodiment also reduces the transmit amplitude in the lower third, i.e., the L beam, where bottom sonar returns are stronger.

In certain embodiments, the angler may use individually selectable UI settings to adjust the power level to each of the (+) electrodes that generate the individual beams. This allows customization by the anger.

In other embodiments, such power adjustments are performed automatically based on deployment mode, desired species, sonar return strength, etc., to cover the various scenarios most commonly encountered in order to provide ease of use for the anglers. In one embodiment the system automatically detects when an angler is fishing shallow water with long casts by detecting the depth of the sonar returns and the forward range set on the head unit used to display the sonar images. The system then automatically adjusts the power provided to each of the (+) electrodes as discussed above to provide the best beam characteristics in such scenario.

Similarly, the system can detect when the angler is fishing deep water with a short forward range based on the sonar depth returns and the forward ranges set on the head unit. The system then automatically adjusts the power provided to each of the (+) electrodes as discussed above to provide the best beam characteristics in that scenario.

Embodiments of the present invention also adjust the power to certain (+) electrodes to vary the beam characteristics for changing conditions in each scenario, even when changes in the set ranges on the head unit or depth readings do not change. In one embodiment the system may increase the power delivered to generate the L beam when moving from a hard to a soft bottom at the same depth, and vice versa. Another embodiment increases the M beam power when coming to a sloped bottom from a flat bottom in order to provide sonar coverage of the increased depth at increased range in front of the boat even though the L beam power is held because the boat is still over the flat portion of the bottom.

As should now be clear to those skilled in the art from the foregoing, embodiments of the present invention provide the ability to vary the power to the plurality of segments of the transmit element for at least the three different orientations enabling Forward, Down, and Landscape operation. In Down and Landscape modes embodiments provide ensonification energy across the full arc of the transducer.

In the Forward mode ensonification may be limited to only a portion of the arc, e.g., approximately 90 to 100 degrees, as discussed above. Using the full arc to transmit in the Forward mode directs about 50 degrees of sound energy up to the water's surface, which will be reflected back down into the water column and causes a delayed “ghost” echo of the fish or bottom structure. As discussed above, the operational mode provided herein at least reduces the energization of the upper segment at reduced power levels.

The data used to control the amount of transmit energy applied to each segment depends on the mode selected, the amplitude of the sonar returns, and the direction of the sonar returns. The underwater factors discussed herein that affect this data include range and depth of returns, bottom hardness, along track and across track slopes, fish schools, and bottom structure. The power supplied to each segment is also affected by the user selections, orientation mode, target enhancement modes, and noise reduction modes. The increase or decrease in the power to the beam will help keep the returns within the dynamic range of the receive electronics and beamformer and help reduce the radial rings resulting from the beamformer sidelobes.

As should also be apparent, the slope of the bottom and the angle of the transducer segments greatly affect the amplitude of the return echo, to wit, upslopes provide for a strong echo and down slopes weak one. Therefore, in the Down mode U beam will see the slope change first and provide less energy for an up slope and more for a down slope, the M beam will be more affected by the top of the slope with a reduction in power and less affected by the sides which might need an increase in power. The L beam will have a weaker return in the approach and a stronger return as it goes down the slope, because the return is more tangential to the pointing direction of the L beam in this orientation. On a flat bottom the M beam will have the stronger return because it is tangent to the bottom and may require less transmit energy. In the Landscape mode the U and L beams become the right and left beams so both beams may see the slope at the same time, or the slope might not be in the field of view of one of the beams so the power would be applied differently.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A transducer for a consumer sonar fishfinder, comprising:
a curved monolithic ceramic element;
a segmented electrode positioned on a radially inward facing concave surface of the curved monolithic ceramic element; and
a single electrode of polarity opposite the segmented electrode, the single electrode positioned on a radially outward facing convex surface of the curved monolithic ceramic element.

2. The transducer of claim 1, wherein the segmented electrode includes a first electrode and a second electrode having a separator posited therebetween.

3. The transducer of claim 2, wherein the separator is defined by a cut, an etch, or a discontinuity in the segmented electrode.

4. The transducer of claim 3, wherein the separator includes an electrically insulating material positioned therein.

5. The transducer of claim 3, wherein the separator comprises an area of no electrical conductivity of a width sufficient to prevent power coupled to one of a first electrode or second electrode from affecting power coupled to the other of the first electrode or second electrode.

6. The transducer of claim 2, wherein the separator is positioned at an angle along the radially inward facing concave surface of the curved monolithic ceramic element such that a first arc length of the first electrode and a second arc length of the second electrode are equal.

7. The transducer of claim 2, wherein the separator is positioned at an angle along the radially inward facing concave surface of the curved monolithic ceramic element such that a first arc length of the first electrode and a second arc length of the second electrode are unequal.

8. The transducer of claim 1, wherein the segmented electrode includes a first electrode, a second electrode, and a third electrode, the first electrode and the second electrode having a first separator posited therebetween, and the second electrode and the third electrode having a second separator posited therebetween.

9. The transducer of claim 8, wherein the first separator is positioned at a first angle along the radially inward facing concave surface of the curved monolithic ceramic element, wherein the second separator is positioned at a second angle along the radially inward facing concave surface of the curved monolithic ceramic element, and wherein the first angle and the second angle are selected such that a first arc length of the first electrode, a second arc length of the second electrode, and a third arc length of the third electrode are equal to one another.

10. The transducer of claim 8, wherein the first separator is positioned at a first angle along the radially inward facing concave surface of the curved monolithic ceramic element, wherein the second separator is positioned at a second angle along the radially inward facing concave surface of the curved monolithic ceramic element, and wherein the first angle and the second angle are selected such that a first arc length of the first electrode, a second arc length of the second electrode, and a third arc length of the third electrode are unequal one another.

11. The transducer of claim 8, wherein the first separator is positioned at a first angle along the radially inward facing concave surface of the curved monolithic ceramic element, wherein the second separator is positioned at a second angle along the radially inward facing concave surface of the curved monolithic ceramic element, and wherein the first angle and the second angle are selected such that at least two of a first arc length of the first electrode, a second arc length of the positive electrode, and a third arc length of the third electrode are equal to one another.

12. The transducer of claim 8, wherein the curved monolithic ceramic element spans an arc of about 150°, and wherein the first separator is positioned at a first angle along the arc and the second separator is positioned at a second angle along the arc such that the first electrode spans about 40°, the second electrode spans about 70°, and the third electrode spans about 40°.

13. The transducer of claim 8, wherein the curved monolithic ceramic element spans an arc of about 150°, and wherein the first separator is positioned at a first angle along the arc and the second separator is positioned at a second angle along the arc such that the first electrode spans about 50°, the second electrode spans about 50°, and the third electrode spans about 50°.

14. The transducer of claim 8, wherein the curved monolithic ceramic element spans an arc of about 150°, and wherein the first separator is positioned at a first angle along the arc and the second separator is positioned at a second angle along the arc such that the first electrode spans about 60°, the second electrode spans about 40°, and the third electrode spans about 50°.

15. The transducer of claim 8, further comprising a first sonar power transmitter operatively coupled to the first electrode, a second sonar power transmitter operatively coupled to the second electrode, and a third sonar power transmitter operatively coupled to the third electrode, the first sonar power transmitter, the second sonar power transmitter, and the third sonar power transmitter each providing individual beam amplitude control for the first electrode, the second electrode, and the third electrode, respectively.

16. The transducer of claim 8, further comprising a single sonar power transmitter operatively coupled to the first electrode via a first high voltage variable resistor, to the second electrode via a second high voltage variable resistor, and to the third electrode via a third high voltage variable resistor, the first high voltage variable resistor, the second high voltage variable resistor, and the third high voltage variable resistor dividing power among the first electrode, the second electrode, and the third electrode to provide beam amplitude control for the first electrode, the second electrode, and the third electrode.

17. The transducer of claim 1, wherein the curved monolithic ceramic element spans an arc between about 150° to about 180°.

18. The transducer of claim 1, further comprising at least one sonar energy absorber positioned within a concave curvature of the curved monolithic ceramic element and an annular element shield housing the curved monolithic ceramic element and the at least one sonar energy absorber therein.

19. The transducer of claim 18, further comprising a backer absorber positioned behind the at least one sonar energy absorber, and wherein the at least one energy absorber includes a top absorber, a middle absorber, and a bottom absorber.

20. A method to provide directional power distribution of sonar energy using the transducer of claim 1, wherein the segmented electrode includes a first electrode, a second electrode, and a third electrode, comprising the steps of:
energizing the first electrode at a first power level to cause the curved monolithic ceramic element to transmit an upper sonar beam (U);
energizing the second electrode at a second power level to cause the curved monolithic ceramic element to transmit a middle sonar beam (M); and
energizing the third electrode at a third power level to cause the curved monolithic ceramic element to transmit a lower sonar beam (L).

21. The method of claim 20, wherein the first power level, the second power level, and the third power level are approximately equal.

22. The method of claim 20, wherein the first power level, the second power level, and the third power level are unequal.

23. The method of claim 20, wherein at least one of the first power level, the second power level, and the third power level is different than at least one other of the first power level, the second power level, and the third power level.

24. The method of claim 20, wherein the steps of energizing comprise the step of varying a respective power level based on at least one of depth, width, distance to a limiting structure, user settings, grazing angle, and composition.

25. The method of claim 20, wherein the step of energizing the third electrode at the third power level to cause the curved monolithic ceramic element to transmit the lower sonar beam (L) comprises the step of varying the third power level based on at least one of depth, width, distance to a limiting structure, user settings, grazing angle, and a bottom composition.

26. The method of claim 20, wherein the step of energizing the first electrode at the first power level to cause the curved monolithic ceramic element to transmit the upper sonar beam (U) comprises the step of reducing the first power level to reduce production of ghost images of targets from reflections of sonar energy from a surface of a fishing environment.

27. The method of claim 20, wherein the step of energizing the first electrode at the first power level to cause the curved monolithic ceramic element to transmit the upper sonar beam (U) comprises the step of setting the first power level to a medium power level to detect a splash of a jig on a surface of a fishing environment while reducing production of ghost images of targets from reflections of sonar energy from the surface.

28. The method of claim 27, wherein the step of energizing the second electrode at the second power level to cause the curved monolithic ceramic element to transmit the middle sonar beam (M) comprises the step of setting the second power level to a maximum power level to track the jig through a water column of the fishing environment.

29. The method of claim 28, wherein the step of energizing the third electrode at the third power level to cause the curved monolithic ceramic element to transmit the lower sonar beam (L) comprises the step of setting the second power level to a minimum power level to reduce generation of side lobes when in one of shallow water or over a hard bottom.

30. The method of claim 20, wherein the step of energizing the first electrode at the first power level to cause the curved monolithic ceramic element to transmit the upper sonar beam (U) comprises the step of setting the first power level to a minimum power level to reduce production of ghost images of targets from reflections of sonar energy from a surface of a fishing environment, and wherein the steps of energizing the second electrode at the second power level to cause the curved monolithic ceramic element to transmit the middle sonar beam (M) and energizing the third electrode at the third power level to cause the curved monolithic ceramic element to transmit the lower sonar beam (L) comprise the steps of setting respective power levels to a maximum power level to track the jig through a water column of the fishing environment.

31. The method of claim 20, wherein the steps of energizing comprise the step of limiting a respective power level based on a maximum power level to prevent damage to the curved monolithic ceramic element.

32. The method of claim 20, wherein the steps of energizing comprise the step of varying a respective power level automatically based on at least one of sonar return amplitude and pulse elongation criteria caused by at least one of depth, width, distance to a limiting structure, grazing angle, composition, housing orientation.
